(19) United States
(12) Patent Application Publication
(10) Pub. No.: US 2025/0371071 A1
(43) Pub. Date: Dec. 4, 2025

(54) SYSTEM AND METHOD FOR PROCESSING ARRAYS

(71) Applicant: UNTETHER AI CORPORATION, Toronto (CA)

(72) Inventor: John Stanley Kitamura, Toronto (CA)

(21) Appl. No.: 18/675,453

(22) Filed: May 28, 2024

(51) Int. Cl. G06F 16/51; G06F 16/56

(52) U.S. Cl. CPC G06F 16/51; G06F 16/56

(57) ABSTRACT

An example computing device includes: a set of processing elements; a controller interconnected with the set of processing elements, the controller configured to: divide an input array into a plurality of strips, each strip comprising at least one primary vector; define a plurality of strip representations, each strip representation comprising a 1-dimensional array representing a respective strip; assign each strip representation to one processing element in the set; control the set of processing elements to process the respective assigned strip representation to obtain a partial result for each element in the strip representation; and aggregate the partial results to obtain a final result representing a characteristic metric for the array.

### FIELD

The specification relates generally to processing arrays, and more particularly to a system and method for processing arrays via streamed inputs.

### BACKGROUND

Frames or arrays of data may be presented as a two-dimensional dataset. When the data is organized in a stored file or produced from a camera, the two-dimensional data in the frame may be presented as a one-dimensional stream of concatenated frame lines. The one-dimensional stream of concatenated frame lines may then be processed by pipelined systems.

### SUMMARY

According to an aspect of the present specification an example computing device includes: a set of processing elements; a controller interconnected with the set of processing elements, the controller configured to: divide an input array into a plurality of strips, each strip comprising at least one primary vector; define a plurality of strip representations, each strip representation comprising a 1-dimensional array representing a respective strip; assign each strip representation to one processing element in the set; control the set of processing elements to process the respective assigned strip representation to obtain a partial result for each element in the strip representation; and aggregate the partial results to obtain a final result representing a characteristic metric for the array.

According to another aspect of the present specification, an example method includes: dividing an input array into a plurality of strips, each strip comprising at least one primary vector; defining a plurality of strip representations, each strip representation comprising a 1-dimensional array representing a respective strip; assigning each strip representation to one processing element in a set of processing elements; processing, by the set of processing elements, the respective assigned strip representation to obtain a partial result for each element in the strip representation; and aggregating the partial results to obtain a final result representing a characteristic metric for the array.

### BRIEF DESCRIPTION OF DRAWINGS

Implementations are described with reference to the following figures, in which:

FIG. 1 depicts a schematic block diagram of an example computing device configured to process an array by streaming inputs.

FIG. 2 depicts a schematic block diagram of a row of processing elements of the computing device of FIG. 1.

FIG. 3 depicts a flowchart of an example method of processing an array by streaming inputs.

FIGS. 4A and 4B depict example array streaming and assignment to processing elements in the computing device of FIG. 1.

FIG. 5 depicts an example pipeline of processing an array with streamed inputs.

### DETAILED DESCRIPTION

Convolutional neural networks contain functions with a two-dimensional kernel window, where pixels from multiple frame lines are used to complete the calculation. In the pipelined implementation where the frame is presented as a one-dimensional stream of concatenated frame lines, pixels are stored and retrieved from line buffers to enable retrieval of the pixels in the kernel window, which may not be consecutive. This line buffering is inefficient and memory-intensive. Further, when a function with a kernel window has a vertical stride greater than one, the provision of the concatenated frame lines at a steady rate results in intermittency in the output stream.

In accordance with the present disclosure, an array may be processed by streaming inputs into strips of the array. For example, the streamed inputs may be one-pixel-wide strips, which may be efficiently processed with a pipelined implementation. Functions with a horizontal factor in a kernel window may copy data from a neighboring strip or strips, and accordingly, the strips may be streamed to adjacent processing elements in a row of processing elements to leverage intra-row connections within the computing device for efficient processing. For functions with a vertical factor in the kernel window, each strip may contain the relevant data in consecutive or nearly consecutive elements.

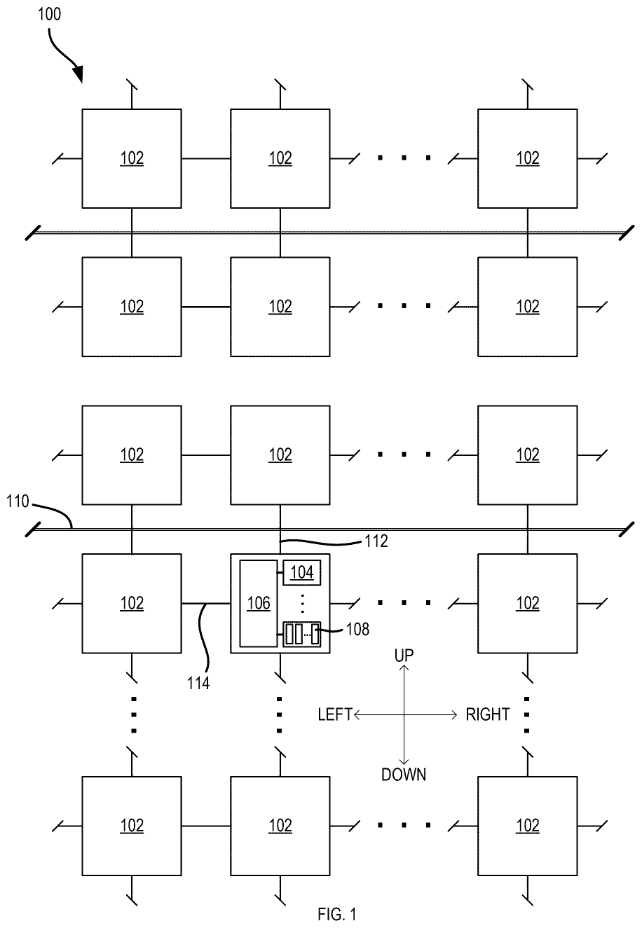

FIG. 1 shows such an example computing device 100. The computing device 100 includes a plurality of banks 102 of processing elements. The banks 102 may be operated in a cooperative manner to implement a parallel processing scheme, such as a SIMD (single instruction/multiple data) scheme.

The banks 102 may be arranged in a regular rectangular grid-like pattern, as illustrated. For sake of explanation, relative directions mentioned herein will be referred to as up, down, vertical, left, right, horizontal, and so on. However, it is understood that such directions are approximations, are not based on any particular reference direction, and are not to be considered limiting. Any practical number of banks 102 may be used. Limitations in semiconductor fabrication techniques may govern. In some examples, 512 banks 102 are arranged in a 32-by-16 grid.

A bank 102 may include a plurality of rows 104 of processing elements (PEs) 108 and a controller 106. A bank 102 may include any practical number of PE rows 104. For example, eight rows 104 may be provided for each controller 106. In some examples, all banks 102 may be provided with the same or similar arrangement of rows. In other examples, substantially all banks 102 are substantially identical. In still other examples, a bank 102 may be assigned a special purpose in the computing device and may have a different architecture, which may omit PE rows 104 and/or a controller 106. Any practical number of PEs 108 may be provided to a row 104. For example, 256 PEs may be provided to each row 104. Continuing the numerical example above, 256 PEs provided to each of eight rows 104 of 512 banks 102 means the computing device 100 includes about 1.05 million PEs 108, less any losses due to imperfect semiconductor manufacturing yield. A PE 108 may be configured to operate at any practical bit size, such as one, two, four, or eight bits. PEs may be operated in pairs to accommodate operations requiring wider bit sizes.

Instructions and/or data may be communicated to/from the banks 102 via an input/output (I/O) bus 110. The I/O bus 110 may include a plurality of segments. A bank 102 may be connected to the I/O bus 110 by a vertical bus 112. Additionally or alternatively, a vertical bus 112 may allow communication among banks 102 in a vertical direction. Such communication may be restricted to immediately vertically adjacent banks 102 or may extend to further banks 102. A bank 102 may be connected to a horizontally neighboring bank 102 by a horizontal bus 114 to allow communication among banks 102 in a horizontal direction. Such communication may be restricted to immediately horizontally adjacent banks 102 or may extend to further banks 102.

Communications through any or all of the busses 110, 112, 114 may include direct memory access (DMA) to memory of the rows 104 of the PEs 108. Additionally or alternatively, such communications may include memory access performed through the processing functionality of the PEs 108.

The computing device 100 may include a main processor (not shown) to communicate instructions and/or data with the banks 102 via the I/O bus 110, manage operations of the banks 102, and/or provide an I/O interface for a user, network, or other device. The I/O bus 110 may include a Peripheral Component Interconnect Express (PCIe) interface or similar.

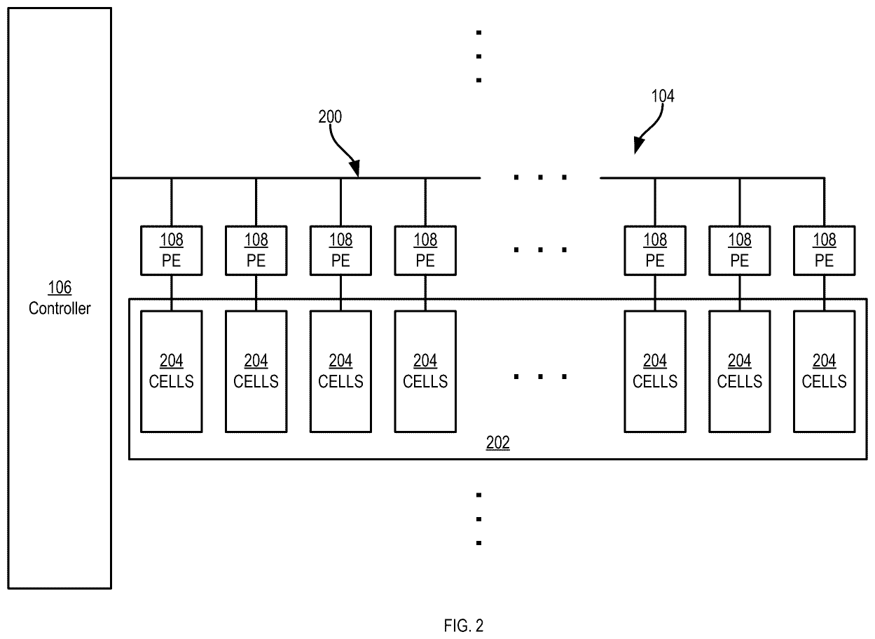

FIG. 2 shows an example row 104 including an array of processing elements 108, which may be physically arranged in a linear pattern (e.g., a physical row) or another suitable pattern or arrangement. For example, the processing elements 108 in the row 104 may be arranged in a looped (e.g., a U-shape) pattern, a rectangular or square array, or the like. Each PE 108 includes an arithmetic logic unit (ALU) to perform an operation, such as addition, multiplication, and so on. The PEs 108 are mutually connected to share or communicate data. For example, interconnections 200 may be provided among the array of PEs 108 to provide direct communication among neighboring PEs 108. The interconnections 200 among the PEs 108 and with the controller 106 are shown schematically for sake of explanation, however the interconnections 200 may be direct connections between two given PEs 108 (e.g., between a given PE 108 and a neighboring PE 108, an n+1 neighbor PE 108, etc.). The endmost PEs 108 at one end of a row 104 may have connections to a controller 106. Additionally or alternatively, end-most PEs 108 of one bank 102 may connect in the same relative manner through the controller 106 and to PEs 108 of an adjacent bank 102. That is, the controller 106 may be connected between two rows 104 of PEs 108 in adjacent banks 102. In other examples, a set of interconnections 200 may be provided to connect PEs 108 in up-down (column-based) connections, so that information may be shared directly between PEs 108 that are in adjacent rows.

A row 104 of PEs 108 may include memory 202 to store data for the row 104. A PE 108 may have a dedicated space in the memory 202. For example, each PE 108 may be connected to a different range of memory cells 204. Any practical number of memory cells 204 may be used. In one example, 144 memory cells 204 are provided to each PE 108.

The controller 106 may control the array of PEs 108 to perform a SIMD operation with data in the memory 202. For example, the controller 106 may trigger the PEs 108 to simultaneously add two numbers stored in respective cells 204.

The controller 106 may communicate data to and from the memory 202 though the PEs 108. For example, the controller 106 may load data into the memory 202 by directly loading data into connected PEs 108 and controlling PEs 108 to shift the data to PEs 108 further in the array. PEs 108 may load such data into their respective memory cells 204. For example, data destined for rightmost PEs 108 may first be loaded into leftmost PEs and then communicated rightwards by interconnections 200 before being stored in rightmost memory cells 204. Other methods of I/O with the memory, such as direct memory access by the controller 106, are also contemplated. The memory cells 204 of different PEs 108 may have the same addresses, so that address decoding may be avoided to the extent possible.

Data stored in memory cells 204 may be any suitable data, such as operands, operators, coefficients, vector components, and similar.

The computing device 100 may be configured to act as a neural network for processing data, for example for applications in image and/or other types of classification, or the like. In particular, each layer of the neural network may be assigned to one or more rows 104 of PEs 108 in one or more banks 102. The results of each layer of the neural network may be passed to a subsequent layer-that is, to another set of rows 104 of PEs 108. In some examples, a given bank 102 may include rows 104 for one layer of the neural network, while in other examples, the bank 102 may include rows 104 for more than one layer of the neural network.

According to an image processing and/or classification application example, layers of the neural network may be configured to analyze the image to identify various features in the image (e.g., edge detection, object detection and the like) and/or assign a metric representative of a certain characteristic, for example for each pixel or set of pixels (e.g., based on a wider kernel or by analyzing every other pixel, every third pixel or other stride length). In particular, for a given pixel, the layer of the neural network may be configured to obtain values for a kernel centered at the given pixel (i.e., a window, such as a 3×3 window centered about the given pixel) to determine the partial result of the characteristic metric for that pixel. Partial results may then be computed by sliding the kernel window through the array of pixels in the image.

Accordingly, in traditional neural network designs, the input image or array may be represented and provided to each layer of the neural network as a one-dimensional array formed by concatenating each row of the image sequentially. Thus, the kernel window may slide along each row, returning to the first column of a subsequent row at the completion of a given row. To process the kernel, in particular when the kernel includes multiple rows of the image, the processing element(s) responsible for implementing the layer of the neural network buffer at least full frame width (i.e., each row of pixels) of pixels to obtain a corresponding pixel in the same column. The buffering requirements may therefore increase based on the height of a kernel for a given computation and/or characteristic metric to be processed by the layer of the neural network. Such buffering may occupy large portions of memory and may be inefficient in distributed, parallel processing schemes. Further, for computations with a stride greater than one (e.g., for computations to be performed on every other pixel or the like), the sequential processing may result in results being provided intermittently and with gaps.

Thus, in accordance with the present disclosure, the computing device 100 may leverage the structure of the banks 102 and the rows 104 of PEs 108 to implement a distributed, parallel processing scheme for implementing the layers of the neural network. In particular, the computing device 100 may be configured to divide an array of data to be processed by the neural network (e.g., representing an image to be analyzed) into a plurality of strips. Each strip includes at least one primary vector extending along a primary dimension of the input array. In a secondary dimension orthogonal to the primary dimension, each strip may include shortened secondary vectors. For example, the array may be divided column-wise into the strips (i.e., the primary vector may be the columns of the input array), with each strip including shortened rows (i.e., the secondary vectors may be the shortened rows of the input array). In other examples, the array may be divided row-wise into strips (i.e., the primary vector may be the rows of the input array), with each strip including shortened columns (i.e., the secondary vectors may be the shortened columns of the input array).

Each strip may then be converted to a 1-dimensional strip representation by concatenating the shortened secondary vectors of the strip and assigned to a processing unit. In the example configuration described herein, a processing unit corresponds to a processing element 108. In other examples, the processing unit may be a row 104 of PEs 108, multiple rows 104 of PEs 108, a bank of PEs 108, or another suitable selection of PEs 108. In particular, adjacent strips may be assigned to adjacent processing units or processing elements 108. Thus, the strips are assigned to a corresponding set of processing elements 108. Since each strip is defined by shortened array (i.e., a shortened row or column), fewer elements need to be buffered for a kernel window spanning multiple rows or columns. Further, elements from adjacent strips may be obtained from neighboring PEs 108 from the connections between the PEs 108. Accordingly, each PE 108 in the set may process elements in the strips in parallel, with the same instruction and processing being performed by each PE 108 for simultaneous and parallel processing scheme (e.g., a SIMD scheme).

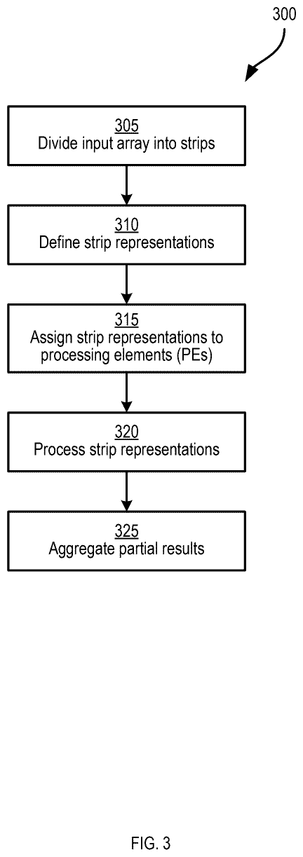

For example, FIG. 3 depicts a flowchart of an example method 300 of processing an array in accordance with the present disclosure. The method 300 will be described in conjunction with its performance by the computing device 100, with reference to the components illustrated in FIGS. 1 and 2. For example, the method 300 may be performed by a controller 106 of one of the banks 102, a series of controllers 106 of a series of banks 102 in combination, a main processor (e.g., a central processing unit (CPU), or the like) of the computing device 100, or another suitable control system or cooperating control systems. In other examples, other suitable devices and/or systems may perform the method 300. Further, in some examples, some or all of the blocks of the method 300 may be performed in an order other than that depicted, including simultaneous performance of some of the blocks, or similar.

At block 305, the computing device 100 is configured to obtain an input array, such as an image including a plurality of pixels (e.g., including multiple data channels representing green, red, and blue contributions to the pixel), a depth map (i.e., including depth data for each pixel in the depth map), or other arrays of data. The computing device 100 is further configured to divide the input array into a plurality of strips. Each strip includes at least one primary vector, wherein the primary vectors are the vectors of the input array defined in a first or primary direction or dimension (e.g., the columns or the rows of the input array). In particular, each strip includes a subset of the primary vectors which form the input array, such that the strip has a smaller dimension in a secondary direction orthogonal to the primary direction.

For example, the input array may be divided column-wise into a plurality of strips, such that each strip includes at least one column of the input array as the primary vector. Accordingly, each strip also includes shortened rows (i.e., as compared to the rows of the input array). Thus, the secondary vectors may be defined by the shortened rows. In other examples, the input array may be divided row-wise into a plurality of strips, such that each of the strips includes at least one row of the input array as the primary vector, and shortened columns as the secondary vector.

In particular, the input array may be divided such that each strip includes one primary vector of the array. In other examples, each strip may include multiple primary vectors. The strips may preferably be equally sized to allow for consistency in subsequent processing of the strips by the PEs 108 for parallel and same-instruction processing. In some examples, the computing device 100 may pad the input array with neutral values (e.g., zero values). For example, padding of the input array may allow the strips to be equally sized. Alternately, padding the input array may provide reference values for kernels having a width or height of greater than one, when the kernel window is centered at the edge elements of the array.

In other examples, the computing device 100 may divide the input array into strips based on the dimensions of the input array and an allocation of the PEs 108 for the neural network. In particular, the computing device 100 may allocate a certain number of PEs 108 to each layer of the neural network. Preferably, for better load distribution and balancing of the network, each layer of the network may be implemented by approximately an equal number of PEs 108. Thus, for a given layer, the computing device 100 may divide the allocated number of PEs 108 into a set of processing units, with each processing unit having at least the number of PEs 108 to carry out the computations to implement the layer. The computing device 100 may also divide the input array into a number of strips equal to the number of processing units.

In some examples, a set of processing units may substantially correspond to a row, with the processing units including multiple rows of PEs 108 according to the number of PEs 108 required to implement the computations for the layer. Accordingly, the input array may be divided into strips such that the number of strips is equal to or less than the number of PEs 108 in a row 104. In other examples, the processing units may correspond to rows 104 of PEs 108, with one or more rows being assigned to perform computations for the layer. Accordingly, the input array may be divided into strips corresponding to the set of rows 104 available for the layer. In other examples, other factors may be considered in selecting the allocated number of rows 104.

At block 310, the computing device 100 is configured to define strip representations for each of the strips obtained at block 305. In particular, the computing device 100 may define the strip representation by concatenating the secondary vectors (i.e., the shortened rows or columns) of the strip sequentially.

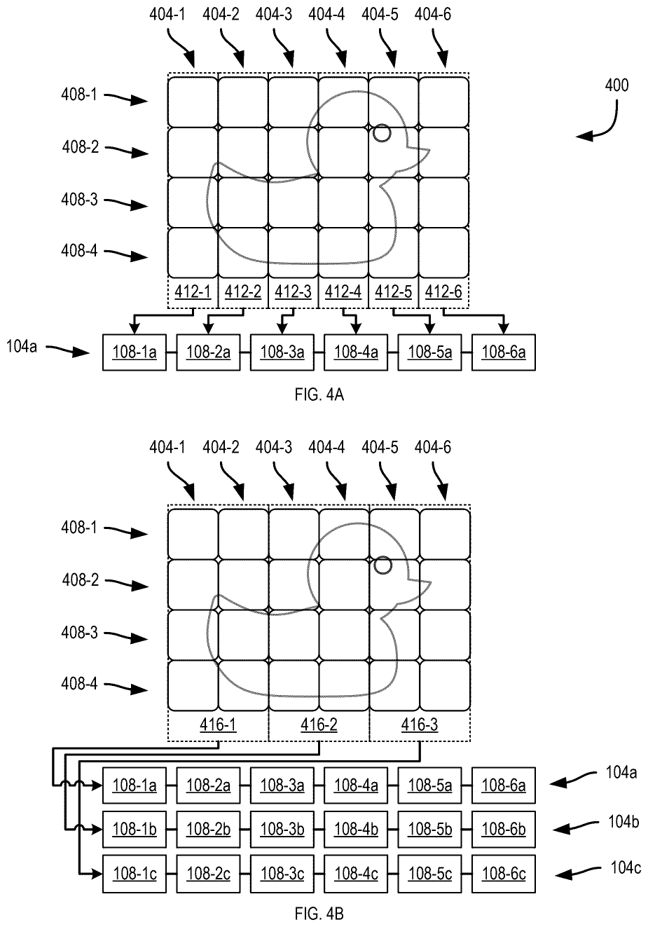

For example, referring to FIGS. 4A and 4B, an example image 400 is depicted. For simplicity, the image 400 is depicted as having six columns 404-1, 404-2, 404-3, 404-4, 404-5, and 404-6 (referred to herein generically as a column 404 and collectively as columns 404; this nomenclature is used elsewhere herein), and four rows 408-1, 408-2, 408-3, and 408-4.

According to a first example as depicted in FIG. 4A, the image 400 may be divided into six strips 412-1, 412-2, 412-3, 412-4, 412-5, and 412-6, with each strip having one column 404 therein. Thus, the columns may be the primary vector in the present example, and at block 310, the strip representation may be defined by the respective columns 404 themselves.

According to a second example as depicted in FIG. 4B, the image 400 may be divided into three strips 416-1, 416-2, and 416-3, with each strip having two columns 404 therein. Each strip is defined by columns as the primary vectors and shortened rows as the secondary vectors. Thus, at block 310, the strip representation may be defined by, for each strip 416, concatenating the elements in the first shortened row 408-1 within the strip, the elements in the second shortened row 408-2, and so on.

Returning to FIG. 3, at block 315, the computing device 100 is configured to assign each strip representation defined at block 310 to one of the PEs 108 in a set. When the processing units to perform the computation for the given layer includes more than one PE 108, the one PE 108 to which the strip representation is assigned may be a first PE in the processing unit. In particular, the computing device 100 may assign adjacent strip representations to adjacent PEs 108. Thus, the spatial relationship of the columns and/or rows of the input array may be substantially maintained in the spatial relationship of the corresponding PEs 108 processing the columns.

Returning to FIG. 4A, each of the strips 412 may be assigned to corresponding PEs 108-1a, 108-2a, 108-3a, 108-4a, 108-5a, and 108-6a in a row 104a. As used herein, the PEs 108 in the row 104a may also be referred to as the PEs 108a; this nomenclature is also used elsewhere herein. That is, in the example of FIG. 4A, the set of PEs 108 to which the strips 412 are assigned corresponds to one of the rows 104.

Referring to FIG. 4B, each of the strips 412 may be assigned to corresponding PEs 108-1a, 108-1b, and 108-1c in corresponding rows 104a, 104b, and 104c, respectively. That is, in the example of FIG. 4B, the set of PEs 108 to which the strips 412 are assigned corresponds to a set of rows 104 (i.e., the set of rows 104a, 104b, and 104c).

Returning again to FIG. 3, at block 320, the computing device 100 is configured to control the processing elements 108 to process the respective assigned strip representation to obtain a partial result for each element in the strip representation.

That is, each PE 108 may be configured to obtain elements from the strip representation sequentially and compute partial results for each element. In particular, each PE 108 may first obtain the first element from the strip representation and perform the suitable convolution, multiplication, addition, or other computation on the respective first elements. Notably, each PE 108 in the set obtains a respective element from a different strip representation, but may perform the same convolution or computation to obtain the partial result, thus allowing a same-instruction scheme to be leveraged and applied to each PE 108 in the set for computational efficiency.

In some examples, the convolution may be a 1×1 convolution, taking as an input the value of the element itself, and constants or other reference values pre-loaded and stored, for example, in the memory cells 204 for the PEs 108 for retrieval and usage during the convolution. In such examples, the convolution may be simply performed by the PE 108 based on the instructions from the controller 106 and the data in the memory cells 204. In some examples, when the computations involved in the convolution utilize more than one PE 108, at block 320, the controller 106 may control the processing unit (i.e., the assigned PEs 108 and subsequent PEs 108) to cooperate to complete the convolution.

In other examples, the convolution may have a wider kernel window in one or both dimensions. When the kernel window is wider in the primary dimension, that is, along the length of the primary vector, then the values which contribute to the convolution may be contained in the primary vector which is assigned to be processed by the same given PE 108. Accordingly, when the kernel window is wider in the primary dimension, to process the strip representation at block 320, the PE 108 may buffer values from the strip representation, for example to be stored in a designated buffer section in the memory cells 204. The PE 108 may then use the buffered values to perform the convolution and obtain the partial result for a given element in the strip representation. Notably, since each strip representation has secondary vectors which are shortened as compared to the original input array (e.g., and preferably may only be up to two to three elements in width), the PEs 108 may only buffer excess elements corresponding to the dimension of the shortened secondary vectors in the strip representation, rather than excess elements for the dimension of the secondary vectors in the input array. Accordingly, particularly for convolutions having a wider kernel window in the primary dimension, the computing device 100 is enabled to reduce the amount of memory and buffering required.

When the kernel window is wider in the secondary dimension, that is, orthogonal to the length of the primary vector, the values which contribute to the convolution may be contained in adjacent primary vectors. For example, where each strip contains precisely one primary vector, neighboring or adjacent elements for the convolution may be contained in adjacent primary vectors, which are assigned to corresponding neighboring PEs 108. Accordingly, the PEs 108 may use the interconnections between the PEs 108 (e.g., the interconnections within a row of PEs 108) to retrieve the adjacent contributing elements for the convolution. For the PEs 108 processing strip representations corresponding to the edges of the input array, the PEs 108 may not have a neighboring PE 108 from which to retrieve a value, and accordingly, the instruction may further specify a condition to use a padded element (e.g., a zero or null value) if a value is not retrievable from an adjacent PE 108. That is, the PE 108 may receive, as additional input values, values from one or more adjacent PEs 108 to perform the convolution and obtain the partial result for a given element in the strip representation. Since each PE 108 is performing the same convolution for different elements of the input array, the PEs 108 may be able to maintain the same-instruction processing, including retrieval of the adjacent contributing elements from respective neighboring or adjacent PEs 108.

In other examples, the strips may include more than one primary vector, and accordingly, at least one of the adjacent elements may be contained within the strip representation being processed by the given PE 108. Accordingly, the PE 108 may similarly buffer values from the strip representation, for example to be stored in a designated buffer section in the memory cells 204. The PE 108 may then use the buffered values to perform the convolution and obtain the partial result for the element of the strip representation.

In some examples, the PE 108 may perform a combination of buffering values and receiving input values from one or more adjacent PEs 108 to perform the convolution. For example, for convolutions having a kernel window with dimensions greater than one in both dimensions (i.e., along the primary vector and orthogonal to the primary vector), the PE 108 may both buffer values from the strip representation and obtain input values from one or more adjacent PEs 108 (including buffered values from the one or more adjacent PEs 108) to perform the convolution.

In particular, since each strip representation is the same width, the relative position of a given element being processed and the relative positions of further contributing elements are equivalent across the set of PEs 108 processing the elements being processed. Accordingly, the set of PEs 108 may be subject to suitable same-instruction processing, including buffering of elements, retrieval of contributing elements from neighboring PEs 108, and the like.

In other examples, convolutions having a wider kernel window in both the primary dimension and the secondary dimension may be decomposed into multiple convolutions having a dimension of one in the primary dimension, and a greater width in the secondary dimension. This may allow the PE 108 to process one decomposed convolution with greater efficiency since the secondary vector values within a strip representation are sequential, and the PE 108 may retrieve contributing elements from adjacent PEs 108 with minimal buffering. The results from the decomposed convolutions may subsequently be combined to obtain the full convolution for the element. In some examples, the decomposed convolutions may be processed by a block of PEs 108, with a first PE 108 processing the first decomposed convolution and sending the result to the second PE 108, and so forth, until the final PE 108 in the block computes the final result. In such examples, the PEs 108 may be configured with residual paths to allow the elements of the strip representation to be directly communicated to the relevant PE 108.

At block 325, the computing device 100 is configured to aggregate the partial results obtained at block 320. In some examples, the aggregation may include processing by one or more further layers of the neural network to determine a characteristic metric for the input array. That is, aggregating the partial results at block 325 may include providing the partial results to a subsequent layer (i.e., a subsequent set of PEs 108) to perform a different convolution or computation. In particular, the PEs 108 may substantially maintain the distribution of the input streams or strips to subsequent sets of PEs 108. In some examples, subsequent layers of the neural network may implement convolutions having a stride of greater than one, and hence the PEs 108 may provide their results to the subsequent set of PEs 108 so as to effect the appropriate stride length of that layer.

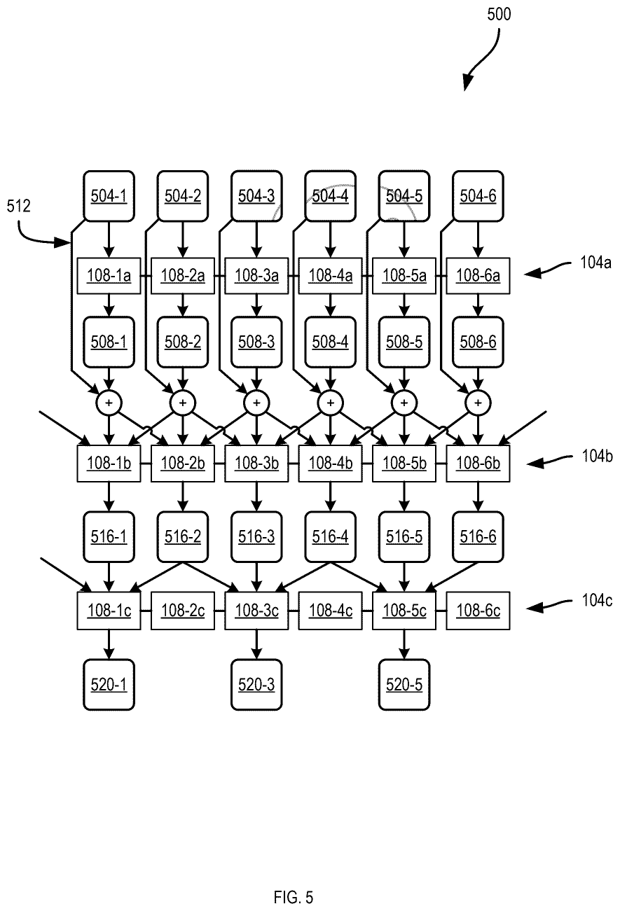

For example, referring to FIG. 5, an example pipeline 500 of processing by the computing device 100 is depicted. In particular, in the present example, the six strips 412 are depicted as being processed by the pipeline 500 via multiple iterations of the method 300. In particular, each element in the strips 412 may be processed via the example pipeline 500.

At a first iteration of the method 300, individual elements 504 of each of the strips 412 are streamed to the respective PEs 108a. In particular, the element 504-1 is streamed to the PE 108-1a, the element 504-2 is streamed to the PE 108-2a, the element 504-3 is streamed to the PE 108-3a, the element 504-4 is streamed to the PE 108-4a, the element 504-5 is streamed to the PE 108-5a, and the element 504-6 is streamed to the PE 108-6a. In the present example, the PEs 108a are configured for a convolution with a horizontal kernel window (i.e., in the secondary dimension perpendicular to the primary vectors of the strips 412) of one. That is, the PEs 108a are configured to receive as inputs only the elements 504 to enable their assigned convolution to be performed. As a result, the PEs 108a produce partial results 508-1, 508-2, 508-3, 508-4, 508-5, and 508-6, respectively.

Subsequently in the pipeline 500, the row 104b of PEs 108 may be configured with a kernel window extending across the strips 412 in the secondary dimension. In particular, in the present example, the PEs 108b have a horizontal kernel window of three and are configured to receive or obtain values from neighboring or adjacent PEs 108. Further, in the present example, the inputs to the PEs 108b may be the sum of the initial input of the elements 504 with the partial results 508 produced by the PEs 108a. The addition of the elements 504 and the partial results 508 may be performed by another row 104 of PEs 108 (not shown), and accordingly, the computing device 100 may further define residual paths 512 to provide the initial input element 504 for the summation with the partial results 508. That is, the residual paths may be formed between originating PEs 108 and destination PEs 108 and may be configured to buffer elements from the input to the originating PEs 108 (i.e., from the strip representations, in the present example) for input to the destination PEs 108. In particular, the residual paths 512 may be required to store fewer elements or values before recombining with the main stream, according to the dimension of the strips in the secondary dimension. The addition of the elements 504 and the partial results 508 may, in other examples, be computed as part of pre-processing by the PEs 108b or as a post-processing of the partial results 508 by the PEs 108a.

After performing the addition, the PEs 108b obtain the three input elements from PEs in adjacent PE groupings to perform the assigned convolution. The edge PEs 108-1b and 108-6b may not have a neighboring PE 108 from which to obtain one of their input values, and accordingly may read a null, zero, or otherwise non-contributing value. The PEs 108b may produce partial results 516-1, 516-2, 516-3, 516-4, 516-5, and 516-6, respectively.

Subsequently in the pipeline 500, the subsequent convolution may be performed with a horizontal stride (i.e., a stride in the secondary dimension perpendicular to the primary vectors of the strips 412) of two. Accordingly, the PEs 108c may be configured to receive two or more inputs (i.e., from different streams), perform the convolution and produce one partial result. In particular, the partial result may represent a convergence of the two or more input streams as a result of the horizontal stride. In the present example, the convolution performed by the PEs 108c may additionally have a horizontal kernel window of three, and hence the PE 108-1c may obtain a padded value, the partial result 516-1, and the partial result 516-2. The PE 108-3c may obtain the partial results 516-2, 516-3, and 516-4. The PE 108-5c may obtain the partial results 516-4, 516-5, and 516-6. In the presently illustrated example, the streams are combined at PEs 108-1c, 108-3c and 108-5c. In other examples, the streams may be combined at adjacent PEs (e.g., 108-1c, 108-2c, and 108-3c), for example, particularly when the assigned PEs 108 are representative of rows 104 of PEs 108 for performing the convolutions, to allow the remainder of the PEs 108 to be utilized for other computations in the neural network. That is, the number of PEs 108 (or processing units) allocated to the layer would be reduced by half or more, according to the stride.

Accordingly, as described herein a computing device may divide an input array into a plurality of strips which each act as input streams for a pipelined system. The streaming of the input array reduces the need for line buffers so that the processing units may be utilized more efficiently for GEMV and other convolutions or computations. Further, a computing device having a PE arrangement as described herein may minimize inter-node connections. In particular, skip connections or residual paths between nodes may be made more efficient since each stream may preferably be one pixel wide (or a small proportion of the input array dimensions), and hence the skip connections may only be required to buffer elements according to the width of the streams or strips.

Padding of the input array may further be made more efficient and may be processed in hardware or software and may dynamically perform the padding when copying values from adjacent strips or streams. Further, when the processing nodes operate on a one pixel wide stream, a vertical stride of greater than one will generate an output at intervals with a regular cadence.

Further advantageously, the neural network processing the array may preferably be load balanced for the resolution, by decreasing pixels while increasing the number of channels per pixel to substantially maintain the amount of computation at a constant. Streaming the input array to a plurality of strips promotes this even distribution, since early layers of the neural network may process frame lines with many pixels and with computational sizes sufficiently small to be processed by a given number of processing units (i.e., individual PEs, PE rows, or other suitable PE groupings). Later layers in the neural network may process frame lines with fewer pixels (i.e., fewer streams) and with larger computational sizes (i.e., processed by a proportionally larger number of PEs), thus allowing the number of PE rows assigned to each layer to be constant. The layout of rows may therefore be constant substantially throughout the neural network.

The scope of the claims should not be limited by the embodiments set forth in the above examples but should be given the broadest interpretation consistent with the description as a whole.

1. A computing device comprising:
a set of processing elements;
a controller interconnected with the set of processing elements, the controller configured to:
divide an input array into a plurality of strips, each strip comprising at least one primary vector;
define a plurality of strip representations, each strip representation comprising a 1-dimensional array representing a respective strip;
assign each strip representation to one processing element in the set;
control the set of processing elements to process the respective assigned strip representation to obtain a partial result for each element in the strip representation; and
aggregate the partial results to obtain a final result representing a characteristic metric for the array.

2. The computing device of claim 1, wherein each strip comprises one primary vector.

3. The computing device of claim 1, wherein the controller is configured to define the strip representation by concatenating secondary vectors of the strip, the secondary vectors being orthogonal to the at least one primary vector.

4. The computing device of claim 1, wherein each processing element in the set is configured to obtain a contributing element from an adjacent processing element to compute the partial result.

5. The computing device of claim 1, wherein each processing element in the set is configured to buffer elements from the strip representation to compute the partial result.

6. The computing device of claim 1, wherein to aggregate the partial results to obtain a final result, the controller is configured to control at least one subsequent set of processing elements to further process the partial results.

7. The computing device of claim 6, wherein the set of processing elements and the at least one subsequent set of processing elements each comprise a layer in a neural network.

8. The computing device of claim 6, further comprising residual paths between the set of processing elements and the at least one subsequent set of processing elements, the residual paths configured to buffer elements from the strip representations for input to the at least one subsequent set of processing elements.

9. The computing device of claim 1, wherein the set of processing elements corresponds to a row of processing elements in the computing device.

10. A method comprising:
dividing an input array into a plurality of strips, each strip comprising at least one primary vector;
defining a plurality of strip representations, each strip representation comprising a 1-dimensional array representing a respective strip;
assigning each strip representation to one processing element in a set of processing elements;
processing, by the set of processing elements, the respective assigned strip representation to obtain a partial result for each element in the strip representation; and
aggregating the partial results to obtain a final result representing a characteristic metric for the array.

11. The method of claim 10, wherein each strip comprises one primary vector.

12. The method of claim 10, wherein defining the strip representation comprises: concatenating secondary vectors of the strip, the secondary vectors being orthogonal to the at least one primary vector.

13. The method of claim 10, wherein each processing element in the set is configured to obtain a contributing element from an adjacent processing element to compute the partial result.

14. The method of claim 10, wherein each processing element in the set is configured to buffer elements from the strip representation to compute the partial result.

15. The method of claim 10, wherein aggregating the partial results to obtain a final result, comprises further processing the partial results by at least one subsequent set of processing elements.

16. The method of claim 15, wherein the set of processing elements and the at least one subsequent set of processing elements each comprise a layer in a neural network.

17. The method of claim 15, further comprising buffering, by residual paths between the set of processing elements and the at least one subsequent set of processing elements, elements from the strip representations for input to the at least one subsequent set of processing elements.

18. The method of claim 10, wherein the set of processing elements corresponds to a row of processing elements in a computing device.
